(19) United States
(12) Patent Application Publication
(10) Pub. No.: US 2015/0327638 A1
(43) Pub. Date: Nov. 19, 2015

(54) APPARATUS, SYSTEM, AND METHOD OF PROVIDING LINKAGE BETWEEN TWO OR MORE OBJECTS SUCH THAT THEY CAN PASSIVELY TRACK OR FOLLOW ONE ANOTHER

(71) Applicant: Debashis GHOSH, Charlotte, NC (US)

(72) Inventor: Debashis GHOSH, Charlotte, NC (US)

(21) Appl. No.: 14/708,701

(22) Filed: May 11, 2015

Related U.S. Application Data
(60) Provisional application No. 61/993,995, filed on May 15, 2014.

(51) Int. Cl. A45C 5/14; A45C 13/00; H04W 4/00

(52) U.S. Cl. CPC A45C 5/14; H04W 4/008; A45C 13/00

(57) ABSTRACT

The present invention provides methods and systems for a mobile device system that includes a electromagnet suitable for physical association with a mobile device, a paired item suitable for association with a user, and a correspondence between the electromagnet and the paired item, wherein the correspondence uniquely pairs at least the electromagnet and the paired item to indicate that the mobile device physically associated with the electromagnet passively follow the user associated with the paired item.

### CROSS REFERENCE TO RELATED PATENT APPLICATION

The current application claims the benefit of the earlier priority filing date of provisional application Ser. No. 61/993,995 that was filed on May 15, 2014.

### FIELD OF THE INVENTION

The present invention relates generally to mobile device, and, more particularly, to a wheeled mobile device, system and method of providing a linkage between two or more objects such that they can passively track or follow one another.

### BACKGROUND OF THE INVENTION

A mobile device, including, but not limited to a wheelchair, stroller, grocery cart, golf caddie, hospital gurneys, luggage and the like, includes wheels allowing it to roll along a surface. All of these mobile device′ have to be pushed or pulled, which can be burdensome because of the difficulty in moving these apparatus for the particular individual and the individual may have other items in their hands.

By way of example, it is well established that one of the most difficult aspects of traveling is maneuvering one's luggage. For example, when traveling alone or in a small party, it may difficult to maneuver multiple bags, as each such bag may require the grasping of a handle and, needless to say, each traveler has only two hands. Consequently, maneuvering more than two bags, or more than one bag if one hand is otherwise occupied holding a child, a coffee, etc., can be of great difficulty. Moreover, when traveling in larger party, such as in a family unit, multiple bags may need to be carried for multiple members of the party by fewer members of the traveling party. For example, two parents may need to maneuver luggage not only for the two parents, but additionally for several children. Maneuvering luggage in the foregoing and other instances can prove difficult, at least for the reasons stated above.

Further, maneuvering luggage in general can be difficult, such as due to the weight of certain luggage, or luggage type, or luggage size. For example, a large piece of luggage filled with heavy materials, such as clothing and souvenirs, can be exceedingly difficult to maneuver through, for example, an airport, particularly when additional items of luggage must be carried by the same person.

Therefore, the need exists for an improved apparatus, system, and method of transporting a mobile device.

### BRIEF SUMMARY OF THE INVENTION

According to an embodiment of the present invention, a mobile device system with a linkage between two or more objects such that they can passively track or follow one another includes an electromagnet suitable for physical association with the luggage, a paired item which is a polymagnet (programmable magnet) suitable for association with a user, and a correspondence between the electromagnet and the paired polymagnet, wherein the correspondence uniquely pairs the electromagnet and the paired polymagnet to indicate that the luggage physically associated with the electromagnet passively follow the user associated with the paired item. The polarities of the magnets can be switched such that the mobile device can be in front of the user. The electromagnet associated with the mobile device is also paired via Bluetooth to a smart phone. In the instance that the distance between the mobile device and the user is far between, the smart phone will vibrate notifying the user that the Bluetooth connection is lost. This way, the user can get closer to his luggage. In this configuration that polymagnet is on the user and the electromagnet is on the mobile device and paired with a Bluetooth smart phone.

According to yet another embodiment of the present invention, the mobile device system includes an electromagnet selectively secured to the mobile device.

According to yet another embodiment of the present invention, the mobile device system includes the first electromagnet implanted into the wheeled mobile device.

According to yet another embodiment of the present invention, the mobile device system includes a correspondence that is a peak spatial attraction force.

According to yet another embodiment of the present invention, the mobile device system includes a correspondence that is an attraction force.

According to yet another embodiment of the present invention, the mobile device system includes a correspondence indicated by Bluetooth.

According to yet another embodiment of the present invention, the mobile device system includes wheels on the bottom side of the mobile device for rolling behind a user.

According to yet another embodiment of the present invention, the mobile device system includes a paired item that is a magnet.

According to yet another embodiment of the present invention, the passively mobile device system includes a first correlated magnet suitable for physical association with the luggage, a second correlated magnet suitable for association with a user, and a peak spatial force between the first correlated magnet and a second correlated magnet, wherein the correspondence uniquely pairs at least the first correlated magnet and the second correlated magnet to indicate that the luggage physically associated with the first correlated magnet passively follow the user associated with the second correlated magnet.

According to yet another embodiment of the present invention, the mobile device system includes a mobile device for assisting with the alignment of the first correlated magnet and second correlated magnet.

According to yet another embodiment of the present invention, the mobile device system includes a second correlated magnet embedded in a mobile device.

According to yet another embodiment of the present invention, the mobile device system includes a release for causing the misalignment of the first correlated magnet and second correlated magnet.

According to yet another embodiment of the present invention, a method for providing a mobile device with a linkage between two or more objects that can passively track or follow one another includes providing a first electromagnet, a paired item suitable for association with a user, and a correspondence between the first electromagnet and the paired item, wherein the correspondence uniquely pairs at least the first electromagnet and the paired item. Engaging the first electromagnet to a luggage item, and corresponding the first electronic element to the paired item, whereby the luggage item passively follows the user with the paired item.

### BRIEF DESCRIPTION OF THE DRAWINGS

The present invention is illustrated and described herein with reference to the various drawings, in which like reference numbers denote like method steps and/or system components, respectively, and in which:

FIG. 1 is a diagram illustrating the features of an exemplary embodiment of the present invention.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

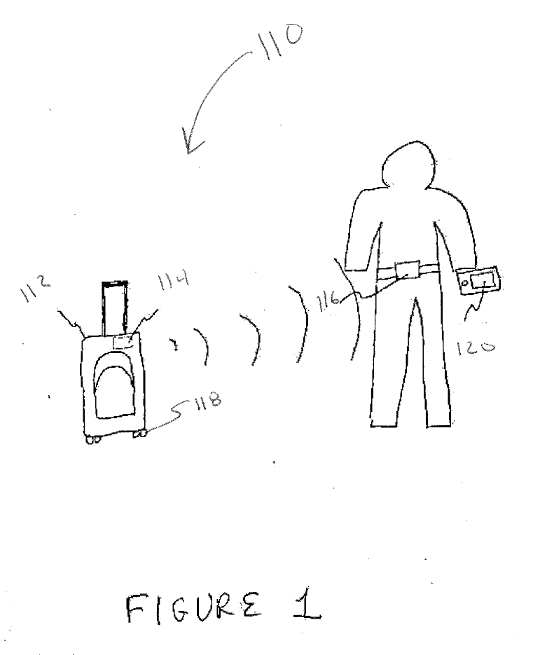

Referring now specifically to the drawing, the system, apparatus, and method for a mobile device with a linkage between two or more objects such that they can passively track or follow one another is illustrated in FIG. 1 and is shown generally at reference numeral 110. The present invention includes at least one mobile device 112, including, but not limited to a wheelchair, stroller, grocery cart, golf caddie, hospital gurneys, luggage item and the like, which mobile device 112 may be specialized in accordance with the present invention, or which may be fit or retrofit for operation in the present invention.

The mobile device 112 in the present invention may be corresponded to the user of the mobile device 112, as discussed herein throughout. For example, an electromagnetic pairing maybe performed between the mobile device 112, such as using an implanted electromagnet or an inserted electromagnet 114, and a paired item 116 on the person of the user. The paired item 116 is preferably a polymagnet. For example, the user may possess the polymagnet 116 that corresponds to the electromagnet 114. The polymagnet may be in the form of a belt buckle, purse buckle, credit card shaped device, polymagnet suitable for placement or clipping in or to a pocket, a purse, a carried item, or the like.

Preferably, the electromagnet 114 and polymagnet 116 may be a correlated magnet. These correlated magnets are composed of a combination of electromagnetic field emission sources which have been configured in accordance with a pre-selected code having desirable properties, which in this case are attraction properties. As such, the electromagnetic field emission sources of the present invention are the electromagnet 114 implanted/inserted into the mobile device 112 and the paired item 116. Therefore, when the electromagnet 114 is brought into alignment with the paired item 116, the structures will align causing a peak spatial attraction force to be produced. The misalignment of the electromagnet 114 with the paired item 116 cancels each other out in a manner that is a function of the particular code used to design the electromagnet 114 and paired item 116.

The spatial forces, such as attraction and repelling, have a magnitude that is a function of the relative alignment of the electromagnet 114 and paired item 116 and their corresponding spatial force function, the spacing and distance between the electromagnet 114 and paired item 116 and the magnetic field strengths and polarities of the various sources making up the electromagnet 114 and paired item 116. The spatial force functions can be used to achieve precision alignment and precision positioning not possible with basic magnets. The spatial force functions can enable the precise control of magnetic fields and associated spatial forces for use in the present invention. The electromagnet 114 and paired item 116 can cancel each other out when purposely brought out of alignment by a release force. The release force is a direct effect of the correlation coding used to configure the electromagnet 114 and paired item 116, and depending upon the code employed, can be present regardless of whether the alignment of the magnetic field emission structures correspond to a repelling force or attraction force.

In the present invention, when the electromagnet 114 comes in a predetermined proximity to the paired item 116, these structures align causing the peak spatial forces to be produced, resulting in an attraction force between the electromagnet 114 and the paired item 116. The attraction spatial force between the electromagnet 114 and paired item 116 results in the electromagnet keeping a predetermined distance between the electromagnet 114 within or engaged to the mobile device 112 and the paired item 116. By way of example and as illustrated in FIG. 1, the electromagnet 114 may be inserted into a pocket or compartment of a mobile device 112, such as luggage. Alternatively, the electromagnet 114 may be engaged or permanently affixed to the luggage. As the paired item 116 moves, such as the walking of a traveler, the electromagnet 114 engaged to the luggage, causes the luggage to follow behind or trail the paired item 116. The luggage follows or trails the paired item 116 as a result of the attraction force causing the luggage to roll on its wheels.

The correspondence between the electromagnet 114 or paired item 116 may be indicated by Bluetooth, NFC, radio frequency, infrared, or the like. Additionally and alternatively, a mobile device 120 may assist in the alignment of the electromagnet 114 and the paired item 116, causing the peak spatial forces to be produced. The mobile device 120 may correspond the paired item 116 on the person of the user with the electromagnet 114 in the luggage 110 using the aforementioned infrared, Bluetooth, near field communication, cellular communication, or the like, through one or more “apps” on the mobile device 120 with which the traveler may interact. Alternatively, the mobile device 120 may itself form a link to the mobile device via one or more of these same methodologies, such as through the use of an embedded electromagnetic system in the mobile device 120, or the like, and such as based on directives from the traveler to the one or more apps on the mobile device 120.

The electromagnet 114 may be matched as between an associated mobile device 112 and a paired item 116 on the person of a traveler, such that the mobile device 112 may “follow” the traveler within a pre-determined distance, among other factors that may be indicated to the aforementioned app, as the traveler moves about within, for example, an airport. This correspondence between traveler and mobile device 112 may include unique pairings as may be performed generally in the known art, such as for mobile devices. For example, Walsh coding via CDMA, FDMA, TDMA, or the like may be employed in order to match a magnet pair, such as using a directive from a mobile device 120, which thereby allows a large number of matched magnet sets to operate on the same frequency and in a confined space without items of luggage “following” the wrong traveler.

The coding of the electromagnet 114 and paired item 116 may be configured to correspond with the aforementioned mobile device 120. There are many difference types of codes with correlation properties that can be utilized for communicating with the mobile device 120 and the effect of the spatial forces created by the alignment of the electromagnet 114 and paired item 116.

As mentioned above, the luggage or mobile device 112 may be specialized for use in the present invention to include an electromagnet 114 or luggage 112 may be fitted or retro-fitted to operate with the present invention. For example, a card electromagnet or the like may be inserted into a bag, such as within an exterior pocket of the bag or compartment, or may be associated with a bag tag of a bag, or the like. Moreover, it will be understood in light of the disclosure herein that multiple mobile device or luggage electromagnets 114 may be match paired to a single paired item 112 on the person of a traveler.

Additionally, and as referenced above, Bluetooth, NFC, infrared, RF, and the like may be employed to provide unique links that allow a unique pairing as between the user and the mobile device 112. Accordingly, a mobile device 120 that provides such linkage may additionally provide the aforementioned app to allow for “manual” adjustments to the link between the user and the mobile device 112. For example, a manual adjustment to the distance allowed between the user and the mobile device 112 may be performed using the aforementioned app that uniquely links the user to the mobile device 112, or other user functionality may be manually adjustable, such as but not limited to actions when encountering escalators, steps, people-moving walkways, or the like.

As such, one mobile device 112 or several mobile devices 112 may uniquely follow the user. For example, one piece of luggage or several pieces of luggage may uniquely follow or track a traveler through the airport, and the luggage may accordingly include features that allow this following to seamlessly occur. Thereby, the luggage may have a one to one or many to one correspondence to a paired item of the traveler. Moreover, switching between paired items per unit(s) of luggage 112 may be enabled in the present invention. For example, a paired item to an electromagnet associated with a particular piece of luggage may be enabled to instruct a manual switch, whereby the paired luggage may be simultaneously paired to a different device, or whereby the paired luggage may be de-paired from the original device and then paired to the different device. In such a circumstance, for example, a mother having a device paired to luggage, but who needs to take a child to a restroom, may manually switch the luggage pairing to a father's device so that the luggage does not follow the mother to the restroom.

For example, and to further provide for seamless following, the mobile device 112 may preferably include wheels 118 as mentioned above, and/or may comprise “hovercraft”-type features, such an air-pin cushion, that allow the mobile device 112 to move seamlessly over surfaces of varying heights, and further to mount escalators, steps, or the like. Likewise, the mobile device 1112 may include a passive or motorized set of tri-wheels, such as on the outermost lower portions of the mobile device 112, which may allow the mobile device 112 to “step” up or down steps or escalators while following the user. That is, the tri-wheel may be robotic, or may simply operate using the electromagnetic attraction to the user. Yet further, features such as the disclosed air pin cushion or a tri-wheel may be provided in a cart that may be uniquely associated with the user or traveler using the electromagnetic pairing discussed herein, and onto which cart the user or traveler may place his/her luggage. Such a cart may, for example, be provided at a point of travel, such as for rental or free use, and as such may enabled serial pairings for use by one user, and then use by a different user upon return to a dispenser for the cart. In this and other exemplary embodiments, the cart may be motorized, and accordingly may include, for example, battery, solar, or like power sources.

Further, the mobile device 112 may include a capability to de-activate a pairing when a user device comes within a certain distance, i.e., when a user steps closer to the mobile device 112 and/or grabs the mobile device's 112 handle. Thus, the user may be able to hold a handle to go up steps and/or ride an escalator, and/or may be able to enter a proximity zone, such as to simply touch a handle, to “park” luggage on, for example, an escalator or a moving walkway. Likewise, in a cart embodiment, the cart may be equipped with a handle, such that the cart may be treated like a wheeled/handled luggage piece, and such that the cart may enable a “parking” of the luggage on the cart on an escalator or walkway.

Additionally, it may be necessary to ensure that the mobile device 112 used in the present invention does not tip or otherwise become impeded as to its motion. For such purposes, the cart mentioned above may be employed rather than electromagnetically corresponding a piece of luggage to the user. Further, the cart may be weighted in such a manner so as not to allow for tipping, as will be understood by those skilled in the art. Additionally, luggage or mobile device 112 may be weighted for use with the present invention and in the same manner as the aforementioned cart, and/or the electromagnet may include therewith weighting sufficient to avoid tipping of the mobile device 112 or luggage when the electromagnet is suitably placed in association with the mobile device 112 or luggage.

Finally, the unique pairing between a user and a mobile device 112 or traveler and luggage, such as using unique the aforementioned or alternative coding systems via FDMA, TDMA, CDMA, or the like, may allow for the provision of additional features in association with the present invention. For example, luggage may “follow along” behind an airplane, a car, a train, or the like, via predetermined distance, rather than traveling in a cargo bay or a trunk of any of the foregoing as is presently typical.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A mobile device system, comprising:
a first electromagnet suitable for physical association with the luggage;
a paired item suitable for association with a user; and
a correspondence between the first electromagnet and the paired item, wherein the correspondence uniquely pairs at least the first electromagnet and the paired item to indicate that the mobile device physically associated with the first electromagnet passively follow the user associated with the paired item.

2. The mobile device system according to claim 1, wherein the first electromagnet and paired item are correlated magnets.

3. The mobile device system according to claim 1, wherein the first electromagnet is selectively secured to the luggage.

4. The mobile device system according to claim 1, wherein the first electromagnet is implanted into the luggage.

5. The mobile device system according to claim 1, wherein the correspondence is a peak spatial attraction force.

6. The mobile device system according to claim 1, wherein the correspondence is an attraction force.

7. The mobile device system according to claim 1, wherein the correspondence is indicated by Bluetooth.

8. The mobile device system according to claim 1, further comprising a bottom side with wheels.

9. The mobile device system according to claim 1, wherein the paired item is a polymagnet.

10. A mobile device system, comprising:
a correlated magnet suitable for physical association with the luggage;
a polymagnet magnet suitable for association with a user; and
a peak spatial force between the first correlated magnet and the polymagnet magnet, wherein the correspondence uniquely pairs at least the correlated magnet and the polymagnet to indicate that the mobile device physically associated with the correlated magnet passively follow the user associated with the polymagnet.

11. The mobile device system according to claim 1, wherein the peak special force is an attraction force.

12. The mobile device system according to claim 1, wherein the correlated magnet is a card that is inserted into the luggage.

13. The mobile device system according to claim 1, further comprising a mobile device for assisting with the alignment of the correlated magnet and polymagnet.

14. The mobile device system according to claim 1, wherein the polymagnet is embedded in a mobile device.

15. The mobile device system according to claim 1, further comprising a release for causing the misalignment of the first correlated magnet and poly magnet.

16. A method for providing a mobile device with a linkage between two or more objects that can passively track or follow one another, comprising:
providing a electromagnet, a paired item suitable for association with a user, and a correspondence between the electromagnet and the paired item, wherein the correspondence uniquely pairs at least the electromagnet and the paired item;
engaging the electromagnet to a mobile device;
corresponding the electronic element to the paired item, whereby the mobile device passively follows or tracks the user with the paired item.

17. The method for providing a mobile device with a linkage between two or more objects that can passively track or follow one another according to claim 16, wherein the first electromagnet and paired item are correlated magnets.

18. The method for providing a mobile device with a linkage between two or more objects that can passively track or follow one another according to claim 16, wherein the correspondence is a peak spatial attraction force.

19. The method for providing a mobile device with a linkage between two or more objects that can passively track or follow one another according to claim 16, wherein the correspondence is an attraction force.

20. The method of providing a mobile device with a linkage between two or more objects that can passively track or follow one another according to claim 16, wherein the correspondence is indicated by Bluetooth.
